(19) United States
(12) Patent Application Publication
(10) Pub. No.: US 2026/0184150 A1
(43) Pub. Date: Jul. 2, 2026

(54) METAL STRIP, AND METHOD FOR PRODUCING SAME

(71) Applicant: BFC FAHRZEUGTEILE GMBH, Bietigheim-Bissingen (DE)

(72) Inventor: Ali YILDIRIM, Waiblingen (DE)

(73) Assignee: BFC FAHRZEUGTEILE GMBH, Bietigheim-Bissingen (DE)

(21) Appl. No.: 18/863,477

(22) PCT Filed: Apr. 26, 2023
(86) PCT No.: PCT/EP2023/061023

§ 371 Date: Nov. 6, 2024

(30) Foreign Application Priority Data
May 10, 2022 (DE) 20 2022 102 549.5

(51) Int. Cl. B60J 10/20; B21B 1/24; B21B 15/00; F16J 15/02

(52) U.S. Cl. CPC B60J 10/20; B21B 1/24; B21B 15/0007; F16J 15/022

(57) ABSTRACT

A metal band as an inlay for sealing strips, edge strips or trim strips, in particular for motor vehicles, comprising a plurality of passage openings that follow one another, in particular periodically, in the direction of the longitudinal extent of the metal band and that extend transversely to the longitudinal extent of the metal band. At least two rows of passage openings follow one another in the direction of the longitudinal extent of the metal band. Said rows are disposed next to one another in the direction of the transverse extent of the metal band, and the passage openings of the two rows are arranged alternately offset from one another in the direction of the longitudinal extent of the metal band so that the passage openings of the two rows are not arranged at the same level, viewed in the direction of the longitudinal extent of the metal band.

### CROSS-REFERENCE TO RELATED APPLICATIONS

This application claims foreign priority benefits under 35 U.S.C. § 119 to German Patent Application No. 20 2022 102 549.5 filed May 10, 2022 and International Patent Application No. PCT/EP2023/061023 filed Apr. 4, 2023, the contents of which are hereby incorporated by reference in their entireties.

### FIELD OF THE INVENTION

The present invention relates to a metal band as an inlay for sealing strips, edge strips or trim strips, in particular for motor vehicles, comprising a plurality of passage openings that follow one another, in particular periodically, in the direction of the longitudinal extent of the metal band and that extend transversely to the longitudinal extent of the metal band, wherein at least two rows of passage openings following one another in the direction of the longitudinal extent of the metal band are present, said rows being disposed next to one another in the direction of the transverse extent of the metal band, wherein the passage openings of the two rows are arranged alternately offset from one another in the direction of the longitudinal extent of the metal band so that the passage openings of the two rows are not arranged at the same level, viewed in the direction of the longitudinal extent of the metal band, and to a method for manufacturing such a metal band.

### BACKGROUND OF THE INVENTION

Such metal bands are in particular used in the automotive sector as inlays for sealing strips for sealing engine compartment openings, trunk openings, and door openings. The continuously produced metal bands are coated by rubber and/or flexible plastic and have passage openings in order, among other things, to enable a penetration of the sealing material in the case of metal bands not coated with adhesive and, as a result, to anchor the rubber material or plastic material at the metal band. Furthermore, the passage openings serve to design the flexibility of the metal band as desired. On the other hand, the metal band must have a certain tensile strength since the coating with plastic material or rubber material takes place by extrusion, wherein considerable forces occur in the direction of the longitudinal extent of the metal band.

Before or after the coating with the plastic material or rubber material, such metal bands can be bent into a usually U-shaped clamping profile that is clamped onto the sealing flanges of the opening. To be able to follow the contours of the opening in the process, the clamping profile usually has to be flexible in both the horizontal plane and the vertical plane. Furthermore, the clamping profile should be compressible in the longitudinal direction since the openings to be sealed may have considerable peripheral tolerances and a cutting to length of the sealing strip on site would be very laborious. Sealing strips having a compressible clamping profile can namely preferably be endlessly produced to the maximum occurring length and can be compressed to the actual length during installation. Bonding or vulcanizing these sealing strips together therefore does not have to take place on site so that the sealing strip installation can also be easily performed by robots. A further requirement of a clamping profile comprises exerting as large as possible a clamping force.

### SUMMARY OF THE INVENTION

It is the underlying object of the invention to specify a metal band of the initially mentioned kind that is improved with respect to the requirements mentioned. In particular, a high tensile strength should be optimally combined with a sufficient flexibility and clamping force.

This object is satisfied by a metal band of the initially mentioned kind that is characterized in that the passage openings of the two rows at most minimally overlap one another or at most have a minimal spacing from one another transversely to the longitudinal extent of the metal band.

Due to the at most minimal overlap of the passage openings of the two rows or the at most minimal spacing of the passage openings of the two rows from one another, a kind of neutral fiber results between the two rows of passage openings, i.e. a closed region of the metal band which extends in the direction of the longitudinal extent of the metal band and in which there are no passage openings. A high tensile force of the metal band in the direction of its longitudinal extent hereby results. Nevertheless, a desired flexibility of the metal band, in particular of a clamping profile bent into a U-profile, can be achieved by means of the passage openings.

The overlap in the direction of the transverse extent of the passage openings with one another is preferably 1 mm or less, 0.8 mm or less, 0.5 mm or less, in particular 0.2 mm or less, or 0 mm. Good tensile forces can thus be achieved with a simultaneously high flexibility of the metal band.

The spacing in the direction of the transverse extent of the passage openings from one another is preferably 1 mm or less, 0.8 mm or less, 0.5 mm or less, 0.2 mm or less, or 0 mm. A high tensile force with a great flexibility can hereby also be simultaneously achieved.

According to an embodiment of the invention, the passage openings of at least one of the two rows open into one of the two side margins of the metal band. Therefore, they are then lateral passage openings of the metal band.

According to a further embodiment of the invention, the passage openings of at least one of the two rows do not open into either of the two side margins. These passage openings are then passage openings in the center region of the metal band.

According to another embodiment of the invention, at least one further row of passage openings can be present, wherein the passage openings of the at least one further row can open into one of the two side margins of the metal band or cannot open into either of the two side margins of the metal band. Additional side openings or openings in the center region of the metal band can hereby be provided.

The passage openings of the at least one further row preferably at most overlap the passage openings of one of the two rows whose passage openings at most minimally overlap one another or at most have a minimal spacing from one another. The passage openings of the at least one further row therefore do not extend into the neutral fiber between the passage openings of the two rows mentioned so that the neutral fiber is maintained. However, the passage openings of at least one further row can generally also overlap the passage openings of the two rows. An increased tensile force compared to known metal bands then nevertheless also results.

According to a further embodiment of the invention, two or more pairs of rows can be provided whose passage openings at most minimally overlap one another or whose passage openings at most have a minimal spacing from one another. Two or more so-called neutral fibers thereby result that increase the tensile strength of the metal band in the direction of its longitudinal extent.

The passage openings of the metal band can be arranged symmetrically or asymmetrically to the longitudinal center of the metal band. Asymmetrically designed metal bands have an increased flexibility in a preferred bending direction.

According to a further embodiment of the invention, between a respective two passage openings of an outer row that follow one another in the direction of the longitudinal extent of the metal band, the passage openings of said outer row opening into a side margin of the metal band, a respective two passage openings of an inner row are present that do not open into one of the two side margins of the metal band. When lengthening the band, the passage openings that do not open into one of the two side margins thereby only open half as much as the passage openings that open into one of the two side margins. A neutral web thereby remains between a respective two passage openings that do not open into a side margin and restricts or prevents a constriction of the metal band transverse to its longitudinal extent.

The passage openings that open into a side margin of the metal band can overlap the passage openings that do not open into a side margin.

According to a further embodiment of the invention, a row of passage openings that open into a side margin of the metal band is present in both marginal regions of the metal band, wherein, between a respective two consecutive passage openings of these two rows, a respective two passage openings of a respective further row are arranged that do not open into a side margin. A symmetrical band with good properties can hereby be produced.

According to a further development of this embodiment, the passage openings of these two further rows can form a neutral fiber between them or, between these two further rows, another row of passage openings can be present, wherein the passage openings of this further row, viewed in the direction of the longitudinal extent of the metal band, are preferably located at the level of the passage openings of the two rows present in the marginal regions and/or form a neutral fiber between themselves and the passage openings of the two further rows in each case. A further advantageous variation of the metal band hereby results.

According to another embodiment of the invention, non-opened cuts are present between passage openings that follow one another in the direction of the longitudinal extent of the metal band and that open into one of the two side margins of the metal band. The flexibility of the band can hereby be further increased without significantly reducing the tensile force of the metal band.

The metal band according to the invention can be produced by cutting, in particular rotary knife cutting, punching or laser cutting, wherein the band can be lengthened after the cutting by rolling and/or drawing. The metal band can be produced particularly quickly and cost-effectively by means of rotary cutting and advantageous properties can be achieved.

According to a further embodiment of the invention, in which the metal band is produced by cutting and by a subsequent lengthening, the lengthening preferably takes place until a respective rounding is produced at the end or ends of the passage openings, said end or ends being disposed in the band interior. The band produced in this way largely corresponds to a punched band, but is easier and cheaper to produce.

According to a further embodiment of the invention, the passage openings can have an opening width in the direction of the longitudinal extent of the metal band of 0.8 mm or more, in particular 0.9 mm or more. Due to the relatively large opening width, a comparatively light band results.

The metal band preferably has a thickness of 0.3 mm or more. This has proven to be advantageous for the initially mentioned use, in particular in the automotive sector.

According to a particularly preferred embodiment of the invention, two outer rows of passage openings are present that each open into one of the two side margins of the metal band and are arranged in pairs at the same level, viewed in the direction of the longitudinal extent of the metal band, wherein an inner row of passage openings is present, said passage openings not opening into either of the two side margins of the metal band, and wherein the passage openings of the inner row, viewed in the direction of the longitudinal extent of the metal band, are each arranged between the passage openings, arranged in pairs, of the two outer rows and at most minimally overlap said passage openings of the two outer rows or at most have a minimal spacing therefrom. A particularly cost-effective and stable metal band hereby results.

In this respect, the spacing of the ends at the inner band side of a pair of the passage openings, arranged in pairs, of the two outer rows from one another is preferably smaller than the sum of the respective spacings of the mutually facing ends of the passage openings of the two outer rows and of the passage openings of the inner row from one another. A defined desired breakage point can hereby be produced that is designed as a weak point that can be broken in a defined manner by a breaking process.

According to a further development of the invention, the respective spacing between the ends at the inner band side of the pairs of passage openings of the two outer rows is 5 mm or less, preferably 4 mm or less, further preferably 3.5 mm or less, in particular 3 mm or less, in particular preferably 2 mm or less. The properties of the metal band can thereby be further improved.

According to another further development of the invention, the width of the non-pierced through region between passage openings of the two outer rows, said passage openings following one another in the direction of the longitudinal extent of the metal band, is in each case 3 mm or more, preferably 3.5 mm or more, further preferably 4 mm or more, particularly preferably 5 mm or more, in particular 6 mm or more. The properties of the metal band can hereby also be further improved.

According to another further development of the invention, the opening width of the passage openings of the two outer rows and/or of the inner rows, viewed in the direction of the longitudinal extent of the metal band, is 0.3 mm or more, preferably 0.5 mm or more, further preferably 0.8 mm or more, particularly preferably 1 mm or more, in particular 1.5 mm or more or 2 mm or more. The weight of the metal band can hereby be further advantageously reduced.

The metal band according to the invention can consist of steel, stainless steel or aluminum or of an alloy comprising steel or an alloy comprising aluminum. These materials have proved to be particularly suitable for the metal bands according to the invention.

A method for manufacturing a metal band according to the invention is characterized in that the passage openings are produced by cutting, in particular rotary cutting or laser cutting, and by a subsequent lengthening, in particular rolling and/or drawing, with the metal band being lengthened until or to such an extent that a rounding is produced at the end or ends of the passage openings, said end or ends being disposed in the band interior. A metal band can hereby be produced by means of cutting that largely corresponds to a punched metal band, but is significantly cheaper to manufacture.

According to a further development of the method according to the invention, the metal band is lengthened until or to such an extent that the passage openings have an opening width in the direction of the longitudinal extent of the metal band of 0.8 mm or more, preferably 0.9 mm or more. A particularly light metal band hereby results that nevertheless has a sufficient stability and tensile strength.

### BRIEF DESCRIPTION OF THE DRAWINGS

Embodiment examples of the invention are shown in the drawings and will be described in the following. The drawings show various embodiments, in respective schematic representations.

FIGS. 1 to 21 show various embodiments of the metal band according to the invention.

### DETAILED DESCRIPTION

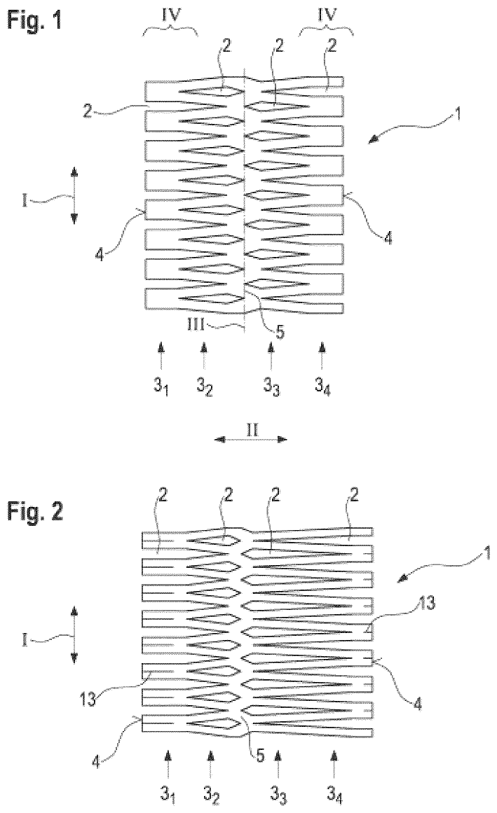

FIG. 1 shows a first embodiment of the metal band 1 according to the invention comprising a plurality of passage openings 2 periodically following one another in the direction of the longitudinal extent I of the metal band 1 and extending transversely to the longitudinal extent I of the metal band 1, wherein four rows 3 of passage openings 2 following one another in the direction of the longitudinal extent I of the metal band 1 are present, said rows being disposed next to one another in the direction of the transverse extent II of the metal band 1. The four rows 3 comprise two outer rows 3₁ and 3₄ whose passage openings 2 each open into a side margin 4 of the metal band 1. Between these two outer rows 3₁ and 3₄, two inner rows 3₂ and 3₃ are arranged whose passage openings 2 do not open into either of the two side margins 4 of the metal margin 1. Both the passage openings 2 of the two outer rows 3₁ and 3₄ and the passage openings 2 of the two inner rows 3₂ and 3₃ are arranged alternately offset from one another in the direction of the longitudinal extent I of the metal band 1 in each case so that these passage openings are each not located at the same level, viewed in the direction of the longitudinal extent I of the metal band 1. However, a respective passage opening 2 of an inner row 3₂, 3₃ that does not open into one of the two side margins 4 of the metal band 1 is located at the same level, viewed in the direction of the longitudinal extent I of the metal band 1, as a passage opening 2 of the two outer rows 3₁ and 3₄ that each open into a side margin 4 of the metal band 1.

According to the invention, the passage openings 2 of the two inner rows 3₂ and 3₃ are arranged such that they at most minimally overlap one another or at most have a minimal spacing from one another transversely to the longitudinal extent I of the metal band 1 so that, between the passage openings 2 of the two inner rows 3₂ and 3₃, a so-called neutral fiber 5 is produced that extends in the direction of the longitudinal extent I of the metal band 1 and is not interrupted by a passage opening 2. In the shown embodiment example of FIG. 1, both the spacing of the respective passage openings 2 of the two inner rows 3₂ and 3₃ and their overlap is exactly 0 so that the neutral fiber 5 extends along a straight line in the direction of the longitudinal extent I of the metal band 1. In the case of a minimal overlap of the passage openings 2 of the two inner rows 3₂ and 3₃, a neutral fiber extending in a slightly wavy manner in the direction of the longitudinal extent I of the metal band 1 would result. In the case of a minimal spacing of said passage openings 2 of the two inner rows 3₂ and 3₃ from one another, the neutral fiber would have a certain width in the direction transverse to the longitudinal extent I of the metal band 1. However, in all cases, due to the neutral fiber 5, an increased tensile strength of the metal band 1 results compared to conventional metal bands without such a neutral fiber. On the other hand, the flexibility of the metal band 1 according to the invention with such a neutral fiber 5 is greater than that of conventional bands with a wide web in the direction of the longitudinal extent of the metal band between respective passage openings.

The overlap of the passage openings 2 with one another is in particular 1 mm or less, 0.8 mm or less, 0.5 mm or less, 0.2 mm or less, or exactly 0 mm. The spacing of the passage openings 2 from one another is in particular 1 mm or less, 0.8 mm or less, 0.5 mm or less, 0.2 mm or less, in particular 0 mm.

The second embodiment of a metal band 1 according to the invention shown in FIG. 2 largely corresponds to that of FIG. 1. However, the neutral fiber 5 is not located at the longitudinal center of the metal band 1, but laterally offset therefrom. In contrast to the embodiment in FIG. 1, it is therefore not a symmetrical but an asymmetrical metal band 1. The passage openings 2 are likewise asymmetrical in that the passage openings at the left-hand side of the metal band in FIG. 2 are shorter in the direction of the transverse extent II of the metal band 1 than the passage openings 2 at the right-hand side of the metal band 1. Furthermore, there are additional, unopened cuts 13 in this embodiment example. These cuts 13 increase the flexibility of the metal band 1 in an advantageous manner and can also be provided in all other embodiments of the metal band according to the invention.

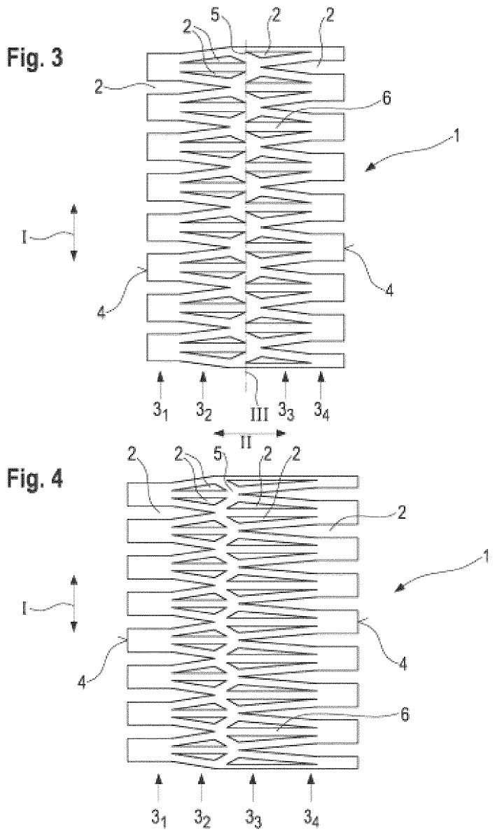

The third embodiment example of the invention shown in FIG. 3 largely corresponds to the first embodiment example of FIG. 1. However, unlike the embodiment example of FIG. 1, a respective two passage openings 2 of the two inner rows 3₂ and 3₃ are in each case arranged between two passage openings 2 of the two outer rows 3₁ and 3₄ that follow another in the direction of the longitudinal extent I of the metal band 1. A web 6 extending in the direction of the transverse extent II of the metal band 1 hereby results in each case between two passage openings 2 of the two inner rows 3₂ and 3₃ that follow one another in the direction of the longitudinal extent I of the metal band 1. This web 6 prevents a constriction in the direction of the transverse extent II of the metal band 1 when lengthening the metal band 1.

The embodiment example of FIG. 4 largely corresponds to the embodiment example of FIG. 3. In contrast thereto, the metal band 1 of the embodiment example of FIG. 4 is, however, not symmetrical, but asymmetrical in that the neutral fiber 5 extends laterally offset from the central longitudinal plane of the metal band 1.

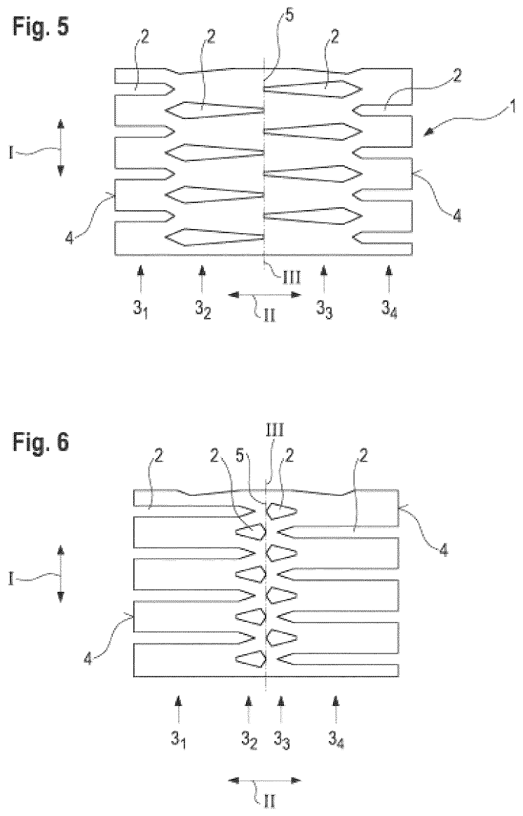

The embodiment example of FIG. 5 differs from that of FIG. 1 substantially in that the passage openings 2 in this regard have different lengths in the direction of the transverse extent II of the metal band 1, namely the passage openings 2 of the two outer rows 3₁ and 3₄ are shorter compared to the embodiment example of FIG. 1 and the passage openings 2 of the two inner rows 3₂ and 3₃ are longer compared to the embodiment example of FIG. 1.

The embodiment example of FIG. 6 likewise only differs slightly from the embodiment example of FIG. 1. Here, the lengths of the passage openings 2 of the two outer rows 3₁ and 3₄ are greater than those of the embodiment example of FIG. 1 and the lengths of the passage openings 2 of the two inner rows 3₂ and 3₃ are shorter than those of the embodiment example of FIG. 1.

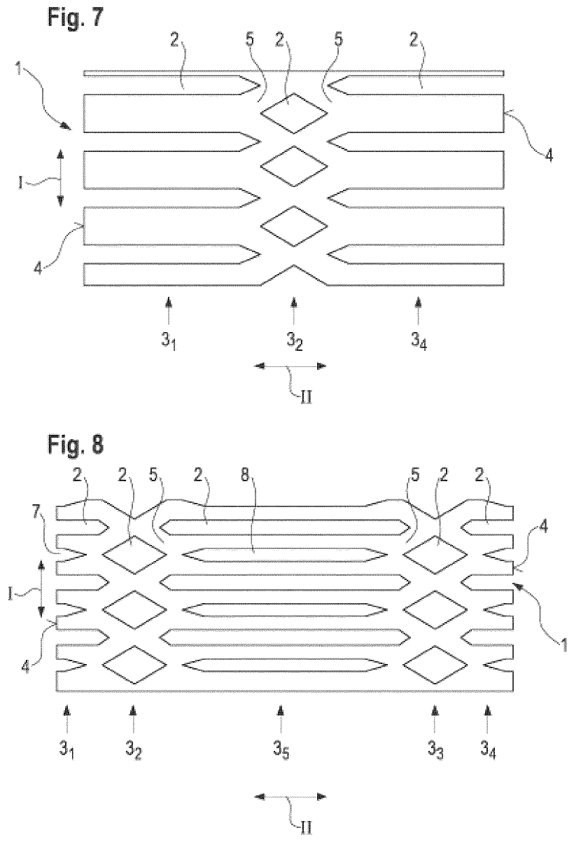

In the embodiment example of FIG. 7, only three rows of passage openings 2 are present, namely two outer rows 3₁ and 3₄ and one inner row 3₂. A respective neutral fiber 5 extends between the passage openings 2 of the two outer rows 3₁ and 3₄ and the passage openings 2 of the inner row 3₂.

The embodiment example of FIG. 8 has five rows of passage openings 2, namely two outer rows 3₁ and 3₄ and three inner rows 3₂, 3₃ and 3₅. A neutral fiber 5 is located between a respective two adjacent rows 3, i.e. a total of four neutral fibers 5. The passage openings 2 of the two outer rows 3₁ and 3₄ are each located at the level of a passage opening 2 of the inner row 3₅, viewed in the direction of the longitudinal extent I of the metal band 1. The metal band 1 of FIG. 8 also has further passage openings 7 and 8, namely further passage openings 7 that each open into a side margin 4 of the metal band 1 and are arranged between a respective two passage openings 2 of the two outer rows 3₁ and 3₄, and further passage openings 8 that do not open into either of the two side margins 4 of the metal band 1 and are arranged between a respective two passage openings 2 of the inner row 3₅. The passage openings 7 and 8 are each located at the same level, viewed in the direction of the longitudinal extent I of the metal band 1.

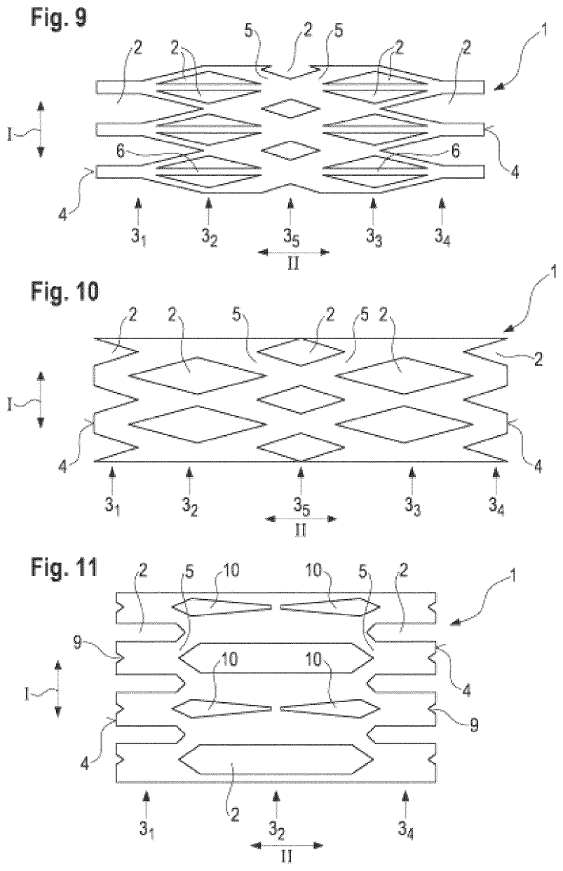

The embodiment example of FIG. 9 likewise has five rows of passage openings 2, namely two outer rows 3₁ and 3₄ and three inner rows 3₂, 3₃ and 3₅. A respective two passage openings 2 of the two adjacent inner rows 3₂ and 3₃ are located between a respective two passage openings 2 of the two outer rows 3₁ and 3₄ that follow one another in the direction of the longitudinal extent I of the metal band 1. The passage openings 2 of the inner row 3₅ are each located at the level of a passage opening 2 of the two outer rows 3₁ and 3₄, viewed in the direction of the longitudinal extent I of the metal band 1. A respective neutral fiber 5 is located between the passage openings 2 of the middle row 3₅ and the two rows 3₂, 3₃ adjacent thereto.

The embodiment example of FIG. 10 largely corresponds to that of FIG. 9. It likewise has five rows of passage openings 2, wherein, however, in contrast to the embodiment example of FIG. 9, only one passage opening 2 of the adjacent row 3₂ or 3₃ is in each case arranged between two passage openings 2 of the two outer rows 3₁ and 3₄ that follow one another in the direction of the longitudinal extent I of the metal band 1.

In the embodiment example of FIG. 11, there are three rows of passage openings 2, namely two outer rows 3₁ and 3₄ and one inner row 3₂, wherein the passage openings 2 of the two outer rows 3₁ and 3₄ do not overlap the passage openings 2 of the inner row 3₂ in the direction of the transverse extent II of the metal band 1 and do not have a spacing from one another in this direction either. However, a minimal overlap or a minimal spacing would be possible. In this respect, the band substantially corresponds to the metal band of FIG. 7. However, there are additional passage openings 9 and 10, namely short passage openings 9 in the direction of the transverse extent II of the metal band 1 between a respective two passage openings 2 of the two outer rows 3₁ and 3₄ that open into a side margin 4 of the metal band 1, and a respective two passage openings 10, which are disposed next to one another in the direction of the transverse extent II of the metal band 1, between a respective two passage openings 2 of the middle row 3₂. These passage openings 10 in each case overlap a passage opening 2 of the two outer rows 3₁ and 3₄ in the direction of the transverse extent II of the metal band 1. In this respect, there is no continuous neutral fiber in the direction of the longitudinal extent I of the metal band 1 in this embodiment example. Nevertheless, the tensile strength of this band is also increased compared to conventional bands in that the passage openings 2 of the two outer rows 3₁ and 3₄ do not overlap the passage openings 2 of the inner row 3₂.

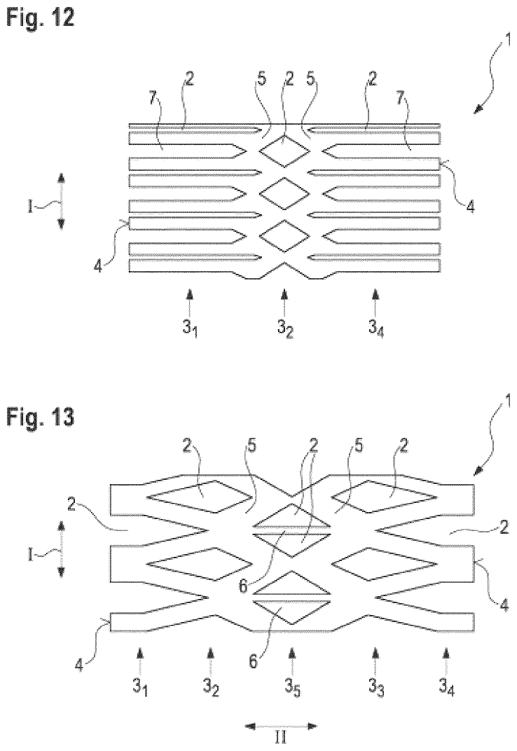

FIG. 12 shows a variant similar to FIG. 7, but with additional passage openings 7, and FIG. 13 shows a variant similar to FIG. 10, but with webs 6 between a respective two passage openings 2 of the middle row 3₅.

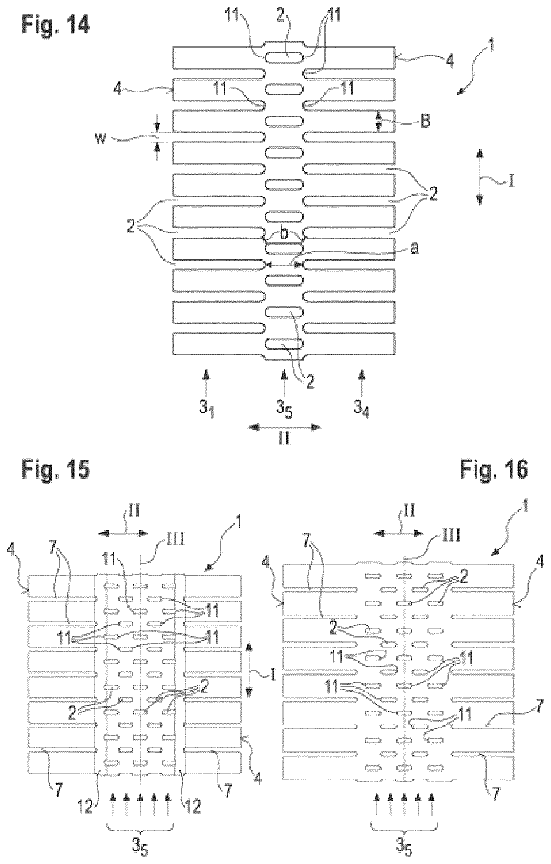

FIGS. 14 to 19 show metal bands according to the invention in various embodiments in which the metal band was produced by cutting and a subsequent lengthening, wherein the lengthening took place until a respective rounding is produced at the end or ends 11 of the passage openings, said end or ends being disposed in the band interior. In this respect, the metal band 1 of FIG. 14 has two outer rows 3₁ and 3₄ and one inner row 3₅ of passage openings 2.

The metal band of FIG. 15 has five inner rows 3₅ of passage openings 2, wherein the passage openings 2 of adjacent rows 3₅ do not overlap one another, viewed transversely to the longitudinal extent of the metal band 1. The passage openings 2 of said rows 3₅ have a rounding at their two band-interior ends 2. The same applies to the band-interior ends 11 of the further passage openings 7. A respective rolling track 12 can be seen between the further passage openings 7 and the passage openings 2 of the respective adjacent inner rows 3₅.

The metal band of FIG. 16 largely corresponds to the metal band of FIG. 15. However, there is no rolling track between the further passage openings 7 and the passage openings 2 of the respective adjacent inner row 3₅.

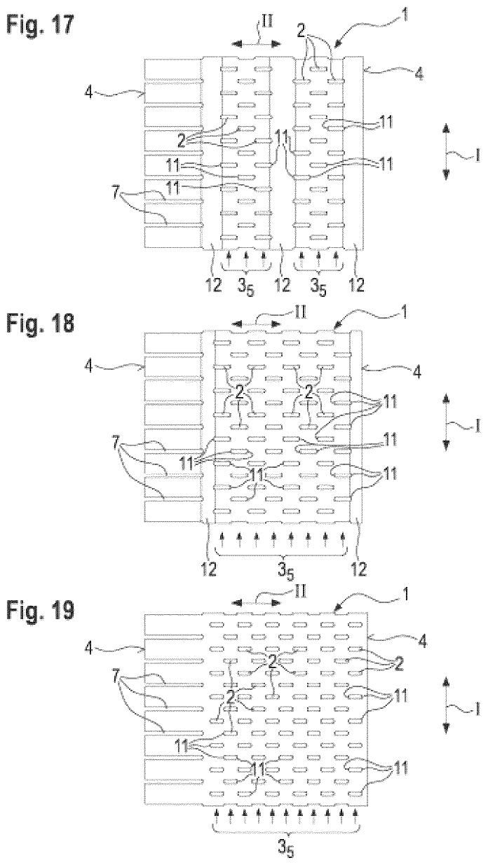

The metal band of FIG. 17 has six inner rows 3₅ of passage openings 2 whose two inwardly disposed ends 11 each have a rounding. Furthermore, the metal band of FIG. 17 has further passage openings 7 at one side that open into a margin 4 of the metal band 1. A rolling track 12 is present between these passage openings 7 and the passage openings 2 of the adjacent inner row 3₅. Equally, a rolling track 12 is present between the third and fourth inner row 3₅ of passage openings 2. And, finally, a rolling track 12 is provided at the side of the metal band facing away from the further passage openings 7.

The metal band of FIG. 18 largely corresponds to the metal band of FIG. 17. However, there are eight inner rows 3₅. Between the further passage openings 7 and the adjacent row 3₅ of passage openings 2, there is again a rolling track 12, likewise at the side of the metal band 1 facing away from the further passage openings 7.

In the metal band in FIG. 19, there are eleven inner rows 3₅ of passage openings 2 and one row of further passage openings 7 that open into a margin 4 of the metal band. This metal band has no rolling tracks 12.

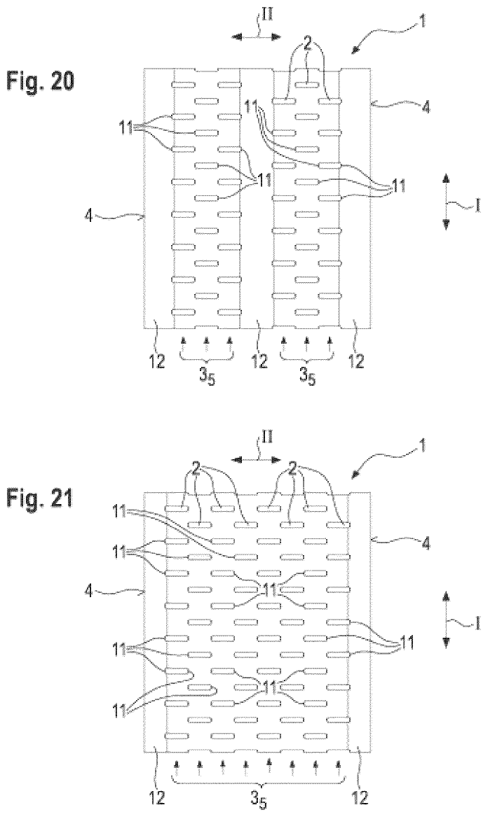

The metal band 1 of FIG. 20 largely corresponds to the metal band 1 of FIG. 17. The metal band 1 of FIG. 20 merely does not have passage openings 7, but is bounded at both side margins 4 by a rolling track 12.

The metal band 1 of FIG. 21 largely corresponds to the metal band 1 of FIG. 18. The metal band 1 of FIG. 21 merely does not have additional passage openings 7, but is bounded at both side margins 4 by a rolling track 12.

### REFERENCE NUMERAL LIST

1 metal band
2 passage opening
3 row
3₁ outer row
3₂ inner row
3₃ inner row
3₄ outer row
3₅ inner row
4 side margin of 1
5 neutral fiber
6 web
7 passage opening
8 passage opening
9 passage opening
10 passage opening
11 band-interior end of 2
12 rolling track
13 cut
a spacing
b spacing
W opening width
B width
I longitudinal extent of 1
II transverse extent of 1
III longitudinal center of 1
IV marginal region of 1

1. A metal band as an inlay for sealing strips, edge strips or trim strips, the metal band comprising a plurality of passage openings that follow one another in the direction of the longitudinal extent of the metal band and that extend transversely to the longitudinal extent of the metal band, wherein at least two rows of passage openings following one another in the direction of the longitudinal extent of the metal band are present, said rows being disposed next to one another in the direction of the transverse extent of the metal band, wherein the passage openings of the two rows are arranged alternately offset from one another in the direction of the longitudinal extent of the metal band so that the passage openings of the two rows are not arranged at the same level, viewed in the direction of the longitudinal extent of the metal band,
wherein
the passage openings of the two rows at most minimally overlap one another or at most have a minimal spacing from one another transversely to the longitudinal extent of the metal band.

2. The metal band according to claim 1,
wherein
the overlap of the passage openings with one another is 1 mm or less, 0.8 mm or less, 0.5 mm or less, 0.2 mm or less, or 0 mm.

3. The metal band according to claim 1,
wherein
the spacing of the passage openings from one another is 1 mm or less, 0.8 mm or less, 0.5 mm or less, 0.2 mm or less, or 0 mm.

4. The metal band according to claim 1, wherein
the passage openings of at least one of the two rows open into one of the two side margins of the metal band.

5. The metal band according to claim 1, wherein
the passage openings of at least one of the two rows do not open into either of the two side margins of the metal band.

6. The metal band according to claim 1, wherein
at least one further row of passage openings is present.

7. The metal band according to claim 6,
wherein
the passage openings of at least one further row open into one of the two side margins of the metal band.

8. The metal band according to claim 6,
wherein
the passage openings of at least one further row do not open into either of the two side margins of the metal band.

9. The metal band according to claim 6,
wherein
the passage openings of the further row or rows at most overlap the passage openings of one of the two rows whose passage openings at most minimally overlap one another or at most have a minimal spacing from one another.

10. The metal band according to claim 1, wherein
two or more pairs of rows are present that have passage openings that are arranged such that they at most minimally overlap one another or at most have a minimal spacing from one another.

11. The metal band according to claim 1, wherein
the passage openings are arranged symmetrically to the longitudinal center of the metal band.

12. The metal band according to claim 1, wherein
the passage openings are arranged asymmetrically to the longitudinal center of the metal band.

13. The metal band according to claim 1, wherein,
between a respective two passage openings of an outer row that follow one another in the direction of the longitudinal extent of the metal band, the passage openings of said outer row opening into a side margin of the metal band, a respective two passage openings of an inner row are present that do not open into one of the two side margins of the metal band.

14. The metal band according to claim 13,
wherein
an outer row comprising passage openings that open into a side margin of the metal band is present in both marginal regions of the metal band, wherein, between a respective two consecutive passage openings of these two rows, a respective two passage openings of a respective further inner row are arranged, wherein the passage openings of these two inner rows do not open into a side margin of the metal band.

15. The metal band according to claim 14,
wherein the passage openings of the two inner rows form a neutral fiber between them.

16. The metal band according to claim 14,
wherein a middle row of passage openings following one another in the direction of the longitudinal extent of the metal band is present between the two inner rows, with a neutral fiber being formed between the middle row and the two inner rows in each case.

17. The metal band according to claim 1, wherein
further passage openings are present, with the further passage openings opening into a side margin or into no side margin of the metal band, with the further passage openings each being arranged between two passage openings of a row of passage openings, viewed in the direction of the longitudinal extent of the metal band.

18. The metal band according to claim 1, wherein
unopened cuts are present between passage openings that follow one another in the direction of the longitudinal extent of the metal band and that open into one of the two side margins of the metal band.

19. The metal band according to claim 1, wherein
the metal band is produced by punching, cutting.

20. The metal band according to claim 19,
wherein
the metal band is produced by cutting and by a subsequent lengthening, with the lengthening taking place until a respective rounding is produced at the end or ends of the passage openings, said end or ends being disposed in the band interior.

21. The metal band according to claim 1,
wherein the passage openings have an opening width in the direction of the longitudinal extent of the metal band of 0.8 mm or more.

22. The metal band according to claim 1,
wherein the metal band has a thickness of 0.3 mm or more.

23. The metal band according to claim 1,
wherein two outer rows of passage openings are present that each open into one of the two side margins of the metal band and are arranged in pairs at the same level, viewed in the direction of the longitudinal extent of the metal band, and in that an inner row of passage openings is present, said passage openings not opening into either of the two side margins of the metal band, with the passage openings of the inner row, viewed in the direction of the longitudinal extent of the metal band, each being arranged between the passage openings, arranged in pairs, of the two outer rows and at most minimally overlapping said passage openings of the two outer rows or at most having a minimal spacing therefrom.

24. The metal band according to claim 23,
wherein the spacing of the ends at the inner band side of a pair of the passage openings, arranged in pairs, of the two outer rows from one another is smaller than the sum of the respective spacings of the mutually facing ends of the passage openings of the two outer rows and of the passage openings of the inner row from one another.

25. The metal band according to claim 23,
wherein the respective spacing between the ends at the inner band side of the pairs of passage openings of the two outer rows is 5 mm or less.

26. The metal band according to claim 23, wherein the width of the non-pierced through region between passage openings of the two outer rows, said passage openings following one another in the direction of the longitudinal extent of the metal band, is in each case 3 mm or more.

27. The metal band according to claim 23, wherein
the opening width of the passage openings of the two outer rows and/or of the inner row, viewed in the direction of the longitudinal extent of the metal band, is 0.3 mm or more.

28. The metal band according to claim 1, wherein
the metal band consists of steel, stainless steel or aluminum or of an alloy comprising steel or aluminum.

29. A method for manufacturing a metal band as an inlay for sealing strips, edge strips or trim strips, the metal band comprising a plurality of passage openings that follow one another in the direction of the longitudinal extent of the metal band and that extend transversely to the longitudinal extent of the metal band, wherein at least two rows of passage openings following one another in the direction of the longitudinal extent of the metal band are present, said rows being disposed next to one another in the direction of the transverse extent of the metal band, wherein the passage openings of the two rows are arranged alternately offset from one another in the direction of the longitudinal extent of the metal band so that the passage openings of the two rows are not arranged at the same level, viewed in the direction of the longitudinal extent of the metal band,
wherein
the passage openings of the two rows transverse to the longitudinal extent of the metal band at most minimally overlap one another or at most have a minimal spacing from one another,
characterized in that
the passage openings are produced by cutting, and by a subsequent lengthening, with the metal band being lengthened until or to such an extent that a rounding is produced at the end or ends of the passage openings, said end or ends being disposed in the band interior.

30. The method according to claim 29,
wherein
the metal band is lengthened until or to such an extent that the passage openings have an opening width in the direction of the longitudinal extent of the metal band of 0.8 mm or more.
